(19) United States
(12) Patent Application Publication
(10) Pub. No.: US 2026/0008675 A1
(43) Pub. Date: Jan. 8, 2026

(54) METHOD FOR MANUFACTURING ELECTRONIC-GRADE SULFURIC ACID

(71) Applicant: KANTO-PPC INC., Taoyuan City (TW)

(72) Inventors: Yu-Hsuan CHENG, Taoyuan City (TW); Chun-Yuan WU, Taoyuan City (TW); Meng-Chieh LU, Taoyuan City (TW); Chih-Hsiang CHIANG, Taoyuan City (TW); Chih-Peng LU, Taoyuan City (TW)

(21) Appl. No.: 19/036,363

(22) Filed: Jan. 24, 2025

(30) Foreign Application Priority Data
Jul. 5, 2024 (TW) 113125344
Jul. 5, 2024 (TW) 113125345

(51) Int. Cl. C01B 17/79; C01B 17/80

(52) U.S. Cl. CPC C01B 17/79; C01B 17/806; C01P 2006/80

(57) ABSTRACT

A method for manufacturing electronic-grade sulfuric acid includes following steps: providing sulfur-containing material; burning the sulfur-containing material with pure oxygen to obtain sulfur dioxide gas; converting the sulfur dioxide gas into sulfur trioxide gas; and processing the sulfur trioxide gas to obtain the electronic-grade sulfuric acid.

### CROSS REFERENCE TO RELATED APPLICATION

This application claims the benefits of the Taiwan Patent Application Serial Numbers 113125344 and 113125345, filed on Jul. 5, 2024, the subject matter of which is incorporated herein by reference.

### BACKGROUND OF THE INVENTION

### 1. Field of the Invention

The present invention relates to a method for manufacturing electronic-grade sulfuric acid, and more particularly to a method for manufacturing electronic-grade sulfuric acid used in semiconductor manufacturing process.

### 2. Description of Related Art

Semiconductor technology has progressed from 5 nanometers to 3 nanometer technologies, and will continue to move toward 2 nanometer technologies in the future. In order to develop semiconductor chips with high performance and low energy consumption, the improvement of chemical purity is becoming increasingly stringent.

In the chemical manufacturing process, purity is mainly affected by the impurity content in the raw materials and pollution in the environment. Common trace pollutants include: particles, metal elements, anions, organic pollutants, oxides, etc. In this regard, it is necessary to purify raw materials, improve filling and packaging technology, and strictly control the environment to avoid the impact of pollution.

In terms of raw material purification, it is necessary to fully understand the chemical characteristics of the raw materials and select suitable chemical processes for raw material purification, which often requires multiple steps to achieve. In addition, chemical filling and packaging need to prevent the introduction of external contamination, or otherwise all efforts will be in vain. Environmental control of chemical manufacturing is also a great challenge. Dust-free, temperature, and humidity are necessary control factors, the air intake and exhaust, and its replacement volume and time must be precisely calculated, and the environmental building materials and production equipment materials must also be specially selected to avoid the introduction of environmental pollution. In short, the process of improving purity is quite complicated and challenging. Every detail therein is intertwined and requires careful attention, so that high-purity products can be produced.

Sulfuric acid is a binary inorganic strong acid. It is known that sulfuric acid is a colorless or light yellow transparent liquid. When describing sulfuric acid, “concentration” is used to express the ratio of solute to solvent, usually in mass percent concentration (%); while “purity” is used to express the amount of impurities. The lower the impurity content, the higher the purity. The so-called “electronic-grade” high-purity sulfuric acid, in which the impurity content of specific items of interest is about parts per billion (ppb), is also called “ppb grade” sulfuric acid. Among the “electronic-grade” high-purity sulfuric acid, there is further the so-called “semiconductor grade” ultra-high purity sulfuric acid, in which the impurity content of specific items of interest is about parts per trillion (ppt), also known as “ppt grade” sulfuric acid.

Usually, the complete electronic-grade sulfuric acid manufacturing process includes the oleum manufacturing process as the front-end process and the electronic-grade sulfuric acid manufacturing process as the back-end process. Herein, the oleum manufacturing process in the front-end uses external air for burning the sulfur. The external air has high moisture content, so that it needs to use industrial-grade sulfuric acid to remove water, which increases the treatment cost and generates a large amount of waste acid. In addition, the oleum manufacturing process in the front-end uses an absorption process to obtain oleum. Since the absorption technology has its inherent limitations and thus sulfur trioxide gas cannot be completely absorbed, there will be industrial-grade sulfuric acid absorbed by the exhaust gas, which causes high waste emissions. Furthermore, in order to improve the purity of sulfur trioxide gas, it requires relatively complicated system equipment, as well as the cost of its subsequent repair and maintenance, thus causing the production cost of electronic-grade sulfuric acid to increase.

Therefore, it is desirable to provide an improved method for manufacturing electronic-grade sulfuric acid to eliminate or mitigate the above problems.

### SUMMARY OF THE INVENTION

In the present invention, “pure oxygen” is used as the carrier gas in the sulfur furnace, and by doing so, it is possible to remove the drying tower process in the traditional sulfuric acid manufacturing process, reducing the usage of industrial-grade sulfuric acid, and having the advantage of reducing treatment costs. In addition, the converter is further combined with the heat exchanger to achieve the effect of simplifying the equipment. On the other hand, in the present invention, sulfur trioxide gas is cooled and condensed by multiple condensing devices connected in series. In this way, sulfur trioxide gas can be directly converted into sulfur trioxide liquid, which not only improves the conversion efficiency and the product quality, but also reduces the industrial-grade sulfuric acid produced by exhaust gas absorption, achieving the goal of high quality and low waste emissions, and realizing the spirit of ESG sustainable development.

In view of this, according to one aspect of the present invention, a method for manufacturing electronic-grade sulfuric acid is provided, which includes the following steps: providing sulfur-containing material; burning the sulfur-containing material with pure oxygen to obtain sulfur dioxide gas; converting the sulfur dioxide gas into sulfur trioxide gas; and processing the sulfur trioxide gas to obtain electronic-grade sulfuric acid. Herein, the pure oxygen contains little or no moisture, and there is no need to perform a water removal step on the pure oxygen. In the present invention, the so-called “pure oxygen” means that the oxygen ratio is above 95%, for example, 96%, 97%, 98%, 99%, 99.5%, 99.8%, 99.9%, or 100%.

According to another aspect of the present invention, a method for manufacturing electronic-grade sulfuric acid is provided, which includes the following steps: providing sulfur-containing material; burning the sulfur-containing material with air to obtain sulfur dioxide gas; converting the sulfur dioxide gas into sulfur trioxide gas; and processing the sulfur trioxide gas with a condensing device to obtain electronic-grade sulfuric acid. Herein, the air still contains moisture, so a water removal step has to be performed on the air.

According to another aspect of the present invention, an equipment for manufacturing electronic-grade sulfuric acid is provided, which includes a sulfur furnace, a converter, an absorption tower, and an evaporator; wherein the converter connects to the sulfur furnace; the absorption tower connects to the converter; and the evaporator connects to the absorption tower. Herein, sulfur-containing material is provided to the sulfur furnace, and the sulfur-containing material is burned with pure oxygen to obtain sulfur dioxide gas; the sulfur dioxide gas is converted into sulfur trioxide gas through the converter; and the sulfur trioxide gas is processed by the absorption tower and the evaporator to obtain electronic-grade sulfuric acid.

According to another aspect of the present invention, an electronic-grade sulfuric acid obtained by performing the aforementioned method for manufacturing electronic-grade sulfuric acid is provided. Herein, the electronic-grade sulfuric acid meets a specification value of any one of calcium, chromium, iron, nickel, potassium, and zinc less than 0.05 ppb and preferably, meets an analytical value of any one of calcium, chromium, iron, nickel, potassium, and zinc less than 0.009 ppb.

In the present invention, a first solvent may be used to absorb the sulfur trioxide gas to obtain oleum, and the oleum may be processes to obtain the electronic-grade sulfuric acid. Herein, the first solvent may be sulfuric acid.

In the present invention, the oleum may be evaporated to obtain evaporated sulfur trioxide gas, and the evaporated sulfur trioxide gas may be processes to obtain the electronic-grade sulfuric acid.

In the present invention, a second solvent may be used to absorb the evaporated sulfur trioxide gas to obtain the electronic-grade sulfuric acid. Herein, the second solvent may be sulfuric acid.

In the present invention, a condensing device may be used to condense the sulfur trioxide gas to obtain sulfur trioxide liquid, and the sulfur trioxide liquid may be processed to obtain the electronic-grade sulfuric acid. Herein, the sulfur trioxide gas may be condensed by a plurality of condensing devices connected in series. For example, the number of the condensing devices connected in series may be at least 2, preferably between 2 and 10.

In the present invention, the sulfur trioxide liquid may be evaporated to obtain evaporated sulfur trioxide gas, and the evaporated sulfur trioxide gas may be processed to obtain the electronic-grade sulfuric acid.

In the present invention, a first solvent may be used to absorb the evaporated sulfur trioxide gas to obtain the electronic-grade sulfuric acid. Herein, the first solvent may be sulfuric acid.

In the present invention, the method may further comprise a step of cooling the sulfur dioxide gas before the step of converting the sulfur dioxide gas into the sulfur trioxide gas.

In the present invention, the temperature of the sulfur dioxide gas before cooling may be between 900° C. and 1100° C., for example, between 950° C. and 1050° C. or about 1000° C.; and the temperature of the sulfur dioxide gas after cooling may be between 300° C. and 500° C., for example, between 350° C. and 450° C. or about 400° C.

In the present invention, the sulfur dioxide gas may be converted into sulfur trioxide gas through a catalyst, and the catalyst may be vanadium pentoxide or alumina. In one embodiment, the catalyst is vanadium pentoxide.

Other novel objects, advantages and features of the present invention will become more apparent from the following detailed description when taken in conjunction with the accompanying drawings.

### BRIEF DESCRIPTION OF THE DRAWINGS

FIG. 1 is a system diagram showing a method for manufacturing electronic-grade sulfuric acid according one comparative embodiment;

FIG. 2 is a diagram showing the process steps according to one comparative embodiment;

FIG. 3 is a system diagram showing a method for manufacturing electronic-grade sulfuric acid according to Embodiment 1 of the present invention;

FIG. 4 is a diagram showing the process steps according to Embodiment 1 of the present invention;

FIG. 5 is a system diagram showing a method for manufacturing electronic-grade sulfuric acid according to Embodiment 2 of the present invention;

FIG. 6 is a diagram showing the process steps according to Embodiment 2 of the present invention; and

FIG. 7 is a system diagram showing a method for manufacturing electronic-grade sulfuric acid according to Embodiment 3 of the present invention.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not mean that there is essentially a level, a rank, an executing order, or a manufacturing order among the elements, except otherwise specified. A “first” element and a “second” element may exist together in the same component, or alternatively, they may exist in different components, respectively. The existence of an element described by a greater ordinal number does not essentially mean the existent of another element described by a smaller ordinal number.

In the present specification, unless otherwise specified, the so-called feature A “and” feature B means that A and B exist at the same time; the so-called “includes”, “comprises”, “has”, and “contains”, mean “including but not limited to”.

Moreover, in the present specification, a value may be interpreted to cover a range within ±10% of the value, and in particular, a range within ±5% of the value, except otherwise specified. A range may be interpreted to be composed of a plurality of subranges defined by a smaller endpoint, a smaller quartile, a median, a greater quartile, and a greater endpoint, except otherwise specified.

### Comparative Embodiment

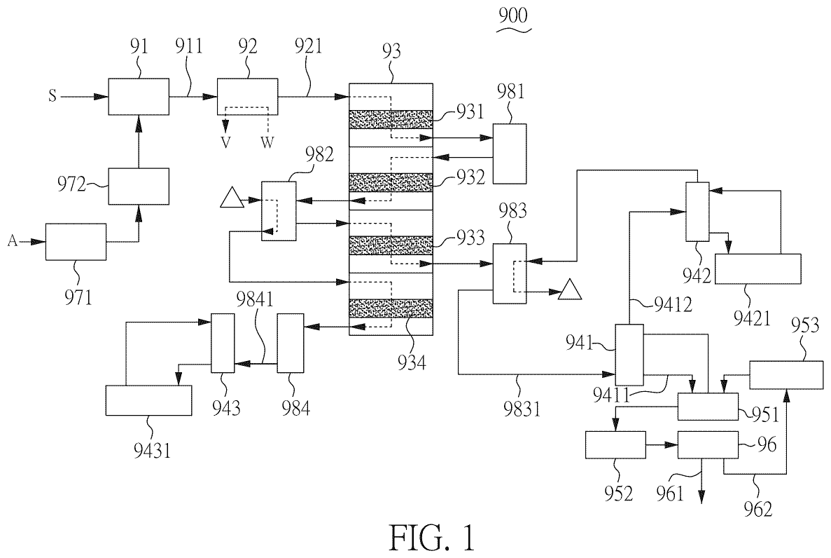

FIG. 1 is a system diagram showing a method for manufacturing electronic-grade sulfuric acid according to one comparative embodiment. In FIG. 1, the electronic-grade sulfuric acid manufacturing process system 900 in the comparative embodiment comprises a sulfur furnace 91, a furnace 92, a converter 93, a first absorption tower 941, a first buffer tank 951, a second buffer tank 952, an evaporator 96, a blower 971, a drying tower 972, a first heat exchanger 981, a second heat exchanger 982, a third heat exchanger 983 and a fourth heat exchanger 984.

First of all, in the electronic-grade sulfuric acid manufacturing process system 900 in the comparative embodiment, in the oleum manufacturing process in the front-end, sulfur S is used as a raw material, and the sulfur S is introduced through a sulfur spray gun (not shown) into the sulfur furnace 91 for burning. The carrier gas used in the sulfur furnace 91 is air A, wherein the air A is the atmospheric air and is mixed gas. The air A must be introduced into the drying tower 972 through the blower 971 before introducing into the sulfur furnace 91. In the drying tower 972, the moisture in the air A is removed by industrial-grade sulfuric acid, which has high water absorption characteristics. The sulfur dioxide gas 911 is produced after the reaction and burning of sulfur S and dry air A.

Based on the temperature range set for the first catalyst 931, the second catalyst 932, the third catalyst 933, and the fourth catalyst 934 in the converter 93, the produced sulfur dioxide gas 911 needs to be cooled by the furnace 92 first, and the cooling mechanism by the furnace 92 is achieved by water W which absorbs heat and vaporizes into water vapor V. The cooled sulfur dioxide gas 921 is introduced into the converter 93, and passes through the first catalyst 931, the first heat exchanger 981, the second catalyst 932, the second heat exchanger 982, the third catalyst 933, and the third heat exchanger 983 in sequence, and thereby converted into sulfur trioxide gas. As the conversion proceeds, the proportion of sulfur trioxide gas is continuously increasing and high-concentration sulfur trioxide gas 9831 is obtained finally. The obtained sulfur trioxide gas 9831 is again absorbed by the low-concentration oleum in the first absorption tower 941 to obtain high-concentration oleum 9411.

Next, in the electronic-grade sulfuric acid manufacturing process system 900 in the comparative embodiment, in the electronic-grade sulfuric acid manufacturing process in the back-end uses the high-concentration oleum 9411 obtained in the oleum manufacturing process in the front-end. The high-concentration oleum 9411 passes through the first buffer tank 951 and the second buffer tank 952, and is introduced into the evaporator 96 in the electronic-grade sulfuric acid manufacturing process and evaporates therein, and evaporated sulfur trioxide gas is thereby obtained. After gas purification and absorption and other processing steps (for simplicity, the gas purification and absorption and other processing steps are omitted in FIG. 1), electronic-grade sulfuric acid 961 is finally obtained.

In addition, considering the limitations in absorption technology, the sulfur trioxide gas 9412 that is not completely absorbed by the first absorption tower 941 is again absorbed by the second absorption tower 942 and stored in the first storage tank 9421. The sulfur trioxide gas 9841 converted by the fourth catalyst 934 and the fourth heat exchanger 984 is absorbed by the third absorption tower 943 and stored in the second storage tank 9431. The oleum 962 that does not evaporate in the evaporator 96 is stored in the third buffer tank 953 and fed back into the first buffer tank 951 for subsequent recycling.

However, the air used in the electronic-grade sulfuric acid process system 900 in the comparative embodiment is the atmospheric air or external air, which is mixed gas with high water content. Therefore, it will not only have a negative impact on the quality of the product, but also need to use industrial-grade sulfuric acid to remove water. This increases processing costs and generates a large amount of industrial-grade sulfuric acid as by-products, which can only be treated as waste acid, and all of this leads to low process efficiency. On the other hand, the electronic-grade sulfuric acid manufacturing process system 900 in the comparative embodiment uses absorption process to obtain oleum. However, since the absorption technology has its inherent limitations, and cannot completely absorb the sulfur trioxide gas, industrial-grade sulfuric acid absorbed by the exhaust gas will then be produced, thus causing high waste emissions. In addition, the electronic-grade sulfuric acid manufacturing process system 900 in the comparative embodiment extracts the sulfur trioxide gas by heating oleum, and absorbing and combining with sulfuric acid to produce electronic-grade sulfuric acid. It cannot directly convert sulfur trioxide gas into sulfur trioxide liquid. In order to improve the purity of sulfur trioxide gas, the electronic-grade sulfuric acid manufacturing process system 900 in the comparative embodiment not only makes the system equipment become quite complicated, but also affects the cost of subsequent repair and maintenance, which in turn increases the production cost of electronic-grade sulfuric acid.

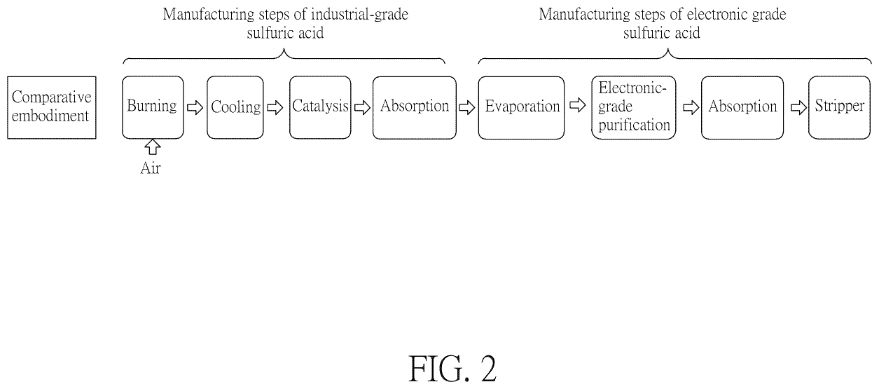

FIG. 2 is a diagram showing the process steps according to one comparative embodiment, which is simplified from the method for manufacturing electronic-grade sulfuric acid in the comparable embodiment. The manufacturing steps in the comparative embodiment shown in FIG. 2 include the manufacturing steps of the industrial-grade sulfuric acid in the comparative embodiment and the manufacturing steps of the electronic-grade sulfuric acid, wherein the manufacturing steps of the industrial-grade sulfuric acid in the comparative embodiment sequentially include the use of air for burning, cooling, catalysis, and absorption, and the manufacturing steps of the electronic-grade sulfuric acid include evaporation, electronic-grade purification, absorption, and stripping in sequence.

According to one aspect of the present invention, which is called the “pure oxygen burning” aspect, the method for manufacturing the electronic-grade sulfuric acid of the present invention includes the following steps: providing sulfur-containing material, wherein the sulfur-containing material is sulfur; burning the sulfur-containing material with pure oxygen to obtain sulfur dioxide gas, wherein there is no need to perform a water removal step on the pure oxygen; cooling the sulfur dioxide gas, wherein the temperature of the sulfur dioxide gas before cooling is between 900° C. and 1100° C., and the temperature of the sulfur dioxide gas after cooling is between 300° C. and 500° C.; converting the cooled sulfur dioxide gas into sulfur trioxide gas through a catalyst, wherein the catalyst is vanadium pentoxide or alumina; using a first solvent to absorb the sulfur trioxide gas to obtain oleum, wherein the first solvent is sulfuric acid; evaporating the oleum to obtain evaporated sulfur trioxide gas; and using a second solvent to absorb the evaporated sulfur trioxide gas to obtain electronic-grade sulfuric acid, wherein the second solvent is sulfuric acid.

According to another aspect of the present invention, which is called the “multi-stage condensation” aspect, the method for manufacturing the electronic-grade sulfuric acid of the present invention comprises the following steps: providing sulfur-containing material, wherein the sulfur-containing material is sulfur; burning the sulfur-containing material with air to obtain sulfur dioxide gas, wherein a water removal step has to be performed on the air; cooling the sulfur dioxide gas, wherein the temperature of the sulfur dioxide gas before cooling is between 900° C. and 1100° C., and the temperature of the sulfur dioxide gas after cooling is between 300° C. and 500° C.; converting the cooled sulfur dioxide gas into sulfur trioxide gas through a catalyst, wherein the catalyst is vanadium pentoxide or alumina; condensing the sulfur trioxide gas by using a plurality of condensing devices connected in series to obtain sulfur trioxide liquid; evaporating the sulfur trioxide liquid to obtain evaporated sulfur trioxide gas; using a first solvent to absorb the evaporated sulfur trioxide gas to obtain the electronic-grade sulfuric acid, wherein the first solvent is sulfuric acid.

Regarding sulfur, the sulfur used in the method for manufacturing electronic-grade sulfuric acid disclosed in the present invention is in form of solid or liquid. However, in practice, as long as the sulfur can be burned to sulfur dioxide gas, it can have any form. Thus, the present invention does not particularly limit the form of sulfur. In addition, the purity of the sulfur used in the method for manufacturing electronic-grade sulfuric acid disclosed in the present invention is 99.5%, for example. However, the purity of the sulfur is unrelated to the purity of the final electronic-grade sulfuric acid pursued by the present invention, and therefore the present invention is not particularly limited to the purity of the sulfur.

Regarding pure oxygen, in the specification and claims of the present invention, even though “pure oxygen” can theoretically exist but it is difficult to realize “pure oxygen” in the reality, so in such case, “pure oxygen” means “high-purity oxygen”. In the present invention, “high-purity oxygen” refers to oxygen having a proportion of 95% or more, for example.

Regarding the combustion (or burning) temperature, the combustion temperature of the method for manufacturing electronic-grade sulfuric acid disclosed in the present invention is between 900° C. and 1100° C., for example. However, there is no particular limitation to the combustion temperature as long as combustion can be achieved.

Regarding the conversion conditions, the conversion condition of the method for manufacturing electronic-grade sulfuric acid disclosed in the present invention is between 300° C. and 500° C., for example.

It can be understood that the steps of the above-mentioned “pure oxygen burning” aspect and the “multi-stage condensation” aspect may be combined or replaced with each other to form more embodiments.

According to another aspect of the present invention, the equipment for manufacturing electronic-grade sulfuric acid of the present invention executes the aforementioned method for manufacturing electronic-grade sulfuric acid.

According to another aspect of the present invention, the electronic-grade sulfuric acid of the present invention is obtained by performing the aforementioned method for manufacturing electronic-grade sulfuric acid, wherein the electronic-grade sulfuric acid meets a specification value of any one of calcium, chromium, iron, nickel, potassium, and zinc less than 0.05 ppb. In addition, the electronic-grade sulfuric acid meets an analytical value of any one of calcium, chromium, iron, nickel, potassium, and zinc less than 0.009 ppb.

### Embodiment 1

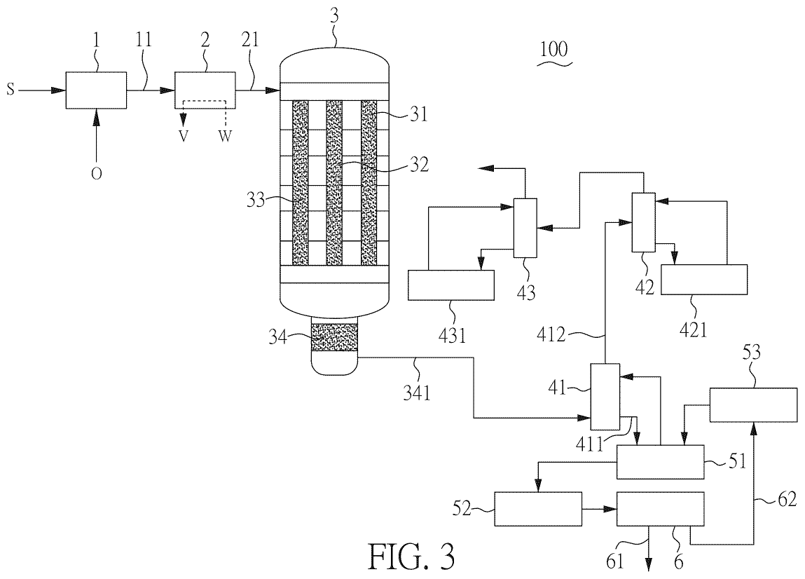

FIG. 3 is a system diagram showing a method for manufacturing electronic-grade sulfuric acid according to Embodiment 1 of the present invention, which mainly illustrates the “pure oxygen burning” aspect of the present invention, but not limited thereto.

As shown in FIG. 3, FIG. 3 shows an electronic-grade sulfuric acid process system 100, which includes a sulfur furnace 1, a furnace 2, a converter 3, a first absorption tower 41, a second absorption tower 42, a third absorption tower 43, a first buffer tank 51, a second buffer tank 52, a third buffer tank 53, and an evaporator 6.

First, in the method for manufacturing electronic-grade sulfuric acid of the present invention, in the oleum manufacturing process in the front-end, sulfur S is used as a sulfur-containing material, and the sulfur S is introduced through a sulfur spray gun (not shown) into the sulfur furnace 1 for burning. The carrier gas used in the sulfur furnace 1 is pure oxygen O. The sulfur dioxide gas 11 is produced after the reaction and burning of the sulfur S and the pure oxygen O. Since the pure oxygen O does not need to undergo a water removal step before being introduced into the sulfur furnace 1, the drying tower in the traditional sulfuric acid production process can be removed (that is, the drying tower 972 shown in FIG. 1 can be removed). Thus, the usage amount of industrial-grade sulfuric acid can be reduced, which has the advantage of reducing processing costs.

Based on the temperature range set for the first catalyst 31, the second catalyst 32, the third catalyst 33, and the fourth catalyst 34 in the converter 3, the produced sulfur dioxide gas 11 needs to be cooled by the furnace 2 first, and the cooling mechanism by the furnace 2 is achieved by water W which absorbs heat and vaporizes into water vapor V. The cooled sulfur dioxide gas 21 is introduced into a specially designed converter 3, wherein the specially designed converter 3 improves the traditional multi-channel heat exchanger shown in FIG. 1 by combining the converter 3 with a heat exchanger, thereby simplifying the equipment as whole, and the converter 3 is preferably a converter with a tube-type structure. The cooled sulfur dioxide gas 21 passes through the first catalyst 31, the second catalyst 32, the third catalyst 33, and the fourth catalyst 34 in the converter 3 in sequence, and is converted into high-concentration sulfur trioxide gas 341. The obtained sulfur trioxide gas 341 is absorbed by the first solvent in the first absorption tower 41 to obtain high-concentration oleum 411.

Next, the electronic-grade sulfuric acid manufacturing process in the back-end uses the high-concentration oleum 411 obtained in the oleum manufacturing process in the front-end is used. The high-concentration oleum 411 passes through the first buffer tank 51 and the second buffer tank 52 in sequence, and is introduced into the evaporator 6 of the electronic-grade sulfuric acid manufacturing process and evaporates therein, and evaporated sulfur trioxide gas is thereby obtained. After electronic-grade purification, absorption by using the second solvent, stripping and other processing steps (for simplicity, these processing steps are omitted in FIG. 2), electronic-grade sulfuric acid 61 is finally obtained.

In this embodiment, considering the limitations of absorption technology, the sulfur trioxide gas 412 that is not completely absorbed by the absorption tower 41 is again absorbed by the second absorption tower 42 and the third absorption tower 43 in sequence and stored in the first storage tank 421 and the second storage tank 431 respectively. The oleum 62 that does not evaporate in the evaporator 6 is stored in the third buffer tank 53 and fed back into the first buffer tank 51 for subsequent recycling.

In this embodiment, the temperature of the sulfur dioxide gas 11 before cooling is about 1000° C., and the temperature of the sulfur dioxide gas 21 after cooling is about 400° C. The first solvent and the second solvent are sulfuric acid. In addition, the first catalyst 31, the second catalyst 32, the third catalyst 33, and the fourth catalyst 34 are respectively vanadium pentoxide, but not limited thereto. In another embodiment, the first catalyst 31, the second catalyst 32, the third catalyst 33, and the fourth catalyst 34 may be alumina. However, the arrangement and number of the aforementioned catalysts are not limited thereto and can be adjusted according to actual needs.

In the method for manufacturing electronic-grade sulfuric acid of this embodiment, sulfur is burned with pure oxygen to generate high-concentration sulfur dioxide. After conversion reaction, high-concentration sulfur trioxide is generated, which is then purified and mixed with oleum to produce ultra-high purity electronic-grade sulfuric acid. The method of this embodiment significantly improves the quality of the product by improving the cleanliness of raw materials. At the same time, since the water removal step is not required when using pure oxygen, it can effectively reduce of low-quality industrial-grade sulfuric acid generated as by-products, thereby achieving the goal of reducing waste in the manufacturing process and improving the enterprise ESG performance.

In the method for manufacturing electronic-grade sulfuric acid in this embodiment, the pure oxygen burning is applied to the sulfuric acid manufacturing process, which has at least the following four commercial values:

1. To improve the cleanliness of raw materials, thereby improving the product quality and creating higher economic value;

2. To significantly increase the productivity of high value-added electronic-grade sulfuric acid under the same sulfur consumption.

3. To use pure oxygen to replace atmospheric air or external air, reduce the air intake volume of the manufacturing process, achieve miniaturization of manufacturing process equipment, and reduce hardware investment, operation cost, and maintenance cost.

4. By burning pure oxygen to have higher heat content, to improve the efficiency of heat energy recycling in the manufacturing process and to provide better conditions for power generation with zero-carbon emission.

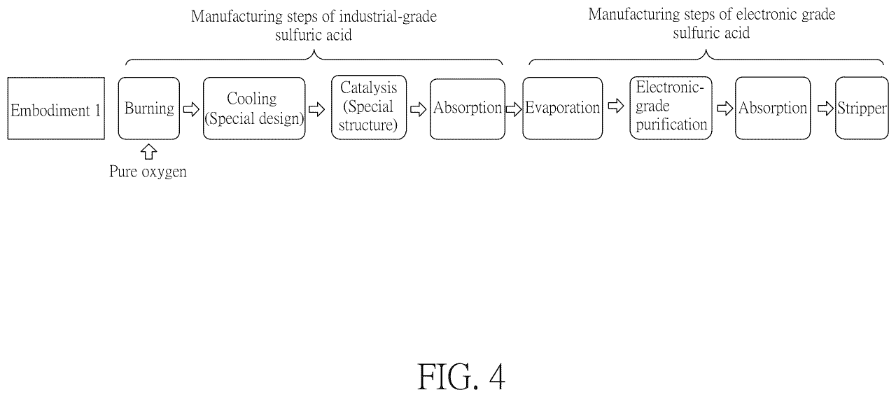

FIG. 4 is a diagram showing the process steps according to Embodiment 1 of the present invention, which is simplified from the method for manufacturing electronic-grade sulfuric acid in Embodiment 1. FIG. 4 shows the process steps in Embodiment 1, which include the process steps of industrial-grade sulfuric acid in Embodiment 1 and the process steps of electronic-grade sulfuric acid. The process steps of industrial-grade sulfuric acid in Embodiment 1 include using pure oxygen for burning, cooling (with special design), catalysis (with special structure), and absorption in sequence. The process steps of electronic-grade sulfuric acid include evaporation, electronic-grade purification, absorption, and stripping in sequence.

### Embodiment 2

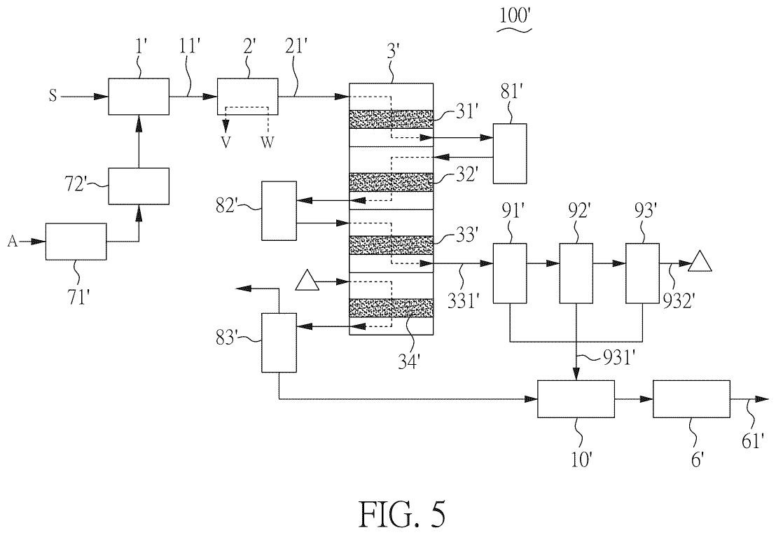

FIG. 5 is a system diagram showing a method for manufacturing electronic-grade sulfuric acid according to Embodiment 2 of the present invention, which mainly illustrates the “multi-stage condensation” aspect of the present invention, but not limited thereto.

As shown in FIG. 5, FIG. 5 shows an electronic-grade sulfuric acid process system 100′, which includes a sulfur furnace 1′, a furnace 2′, a converter 3′, an evaporator 6′, a blower 71′, a drying tower 72′, a first heat exchanger 81′, a second heat exchanger 82′, a third heat exchanger 83′, a first condensing device 91′, a second condensing device 92′, a third condensing device 93′, and a storage tank 10′.

First, in the method for manufacturing electronic-grade sulfuric acid of the present invention, in the oleum manufacturing process in the front-end, sulfur S is used as sulfur-containing material, and the sulfur S is introduced through a sulfur spray gun (not shown) into the sulfur furnace 1′ for burning. The carrier gas used in the sulfur furnace l′ is air A. The air A must be introduced into the drying tower 72′ through the blower 71′ before introducing into the sulfur furnace 1′. In the drying tower 72′, the moisture in the air A is removed by industrial-grade sulfuric acid, which has high water absorption characteristics. The sulfur dioxide gas 11′ is produced after the reaction and burning of sulfur S and dry air A.

Based on the temperature range set for the first catalyst 31′, the second catalyst 32′, the third catalyst 33′, and the fourth catalyst 34′ in the converter 3′, the produced sulfur dioxide gas 11′ needs to be cooled by the furnace 2′ first, and the cooling mechanism by of the furnace 2′ is achieved by water W which absorbs heat and vaporizes into water vapor V. The cooled sulfur dioxide gas 21′ is introduced into the converter 3′, and passes through the first catalyst 31′, the first heat exchanger 81′, the second catalyst 32′, the second heat exchanger 82′, and the third catalyst 33′ in sequence, and thereby convert into sulfur trioxide gas. As the conversion proceeds, the proportion of sulfur trioxide gas is continuously increasing and high-concentration sulfur trioxide gas 331′ is obtained finally. The obtained sulfur trioxide gas 331′ is cooled and condensed by the first condensing device 91′, the second condensing device 92′ and the third condensing device 93′ connected in series into sulfur trioxide liquid 931′ and stored in the storage tank 10′. Since sulfur trioxide gas 331′ is directly converted into sulfur trioxide liquid 931′, it can not only improve the conversion efficiency and the product quality, but also reduce the industrial-grade sulfuric acid produced by exhaust gas absorption, achieving the goal of high quality and low waste emissions, and realizing the spirit of ESG sustainable development.

Next, in the electronic-grade sulfuric acid manufacturing process in the back-end, the obtained sulfur trioxide liquid 931′ is fed back into the evaporator 6′ of the electronic-grade sulfuric acid for evaporation to obtain evaporated sulfur trioxide gas. After electronic-grade purification, absorption by using first solvent, stripping, and other processing steps (for simplicity, these processing steps are omitted in FIG. 3), electronic-grade sulfuric acid 61′ is finally obtained.

In this embodiment, the sulfur trioxide gas 932′ that is not condensed by the third condensing device 93′ will be partially fed back into the storage tank 10′ through the fourth catalyst 34′ and the third heat exchanger 83′. In addition, in this embodiment, the three condensing devices (that is, the first condensing device 91′, the second condensing device 92′, and the third condensing device 93′) are connected in series, but not limited thereto. Multiple condensing devices can be connected in series according to product requirements. For example, the number of condensing devices connected in series can be between 2 and 10.

In this embodiment, the temperature of the sulfur dioxide gas 11′ before cooling, the temperature of the sulfur dioxide gas 21′ after cooling, the first solvent, the first catalyst 31′, the second catalyst 32′, the third catalyst 33′, the fourth catalyst 34′ are similar to those described in Embodiment 1, and are not described again here. In addition, the arrangement and the number of the aforementioned catalysts may also be adjusted according to actual needs.

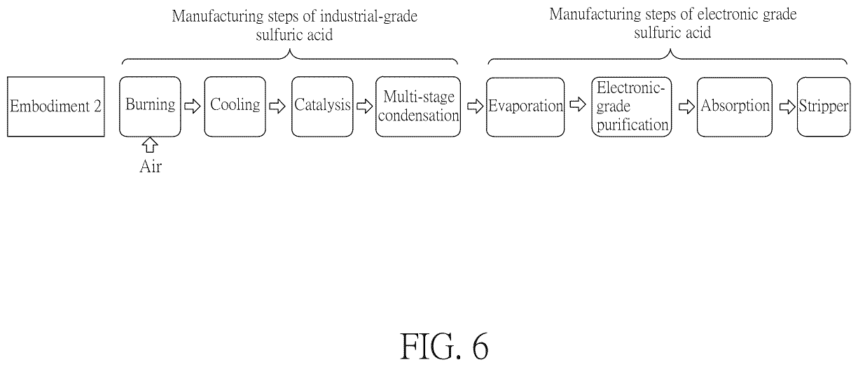

FIG. 6 is a diagram showing the process steps according to Embodiment 2 of the present invention, which is simplified from the method for manufacturing electronic-grade sulfuric acid in Embodiment 2. FIG. 6 shows the process steps in Embodiment 2, which include the process steps of industrial-grade sulfuric acid in Embodiment 2 and the process steps of electronic-grade sulfuric acid. The process steps of industrial-grade sulfuric acid in Embodiment 2 include using air for burning, cooling, catalysis, and multi-stage condensation in sequence. The process steps of electronic-grade sulfuric acid include evaporation, electronic-grade purification, absorption, and stripping in sequence.

### Embodiment 3

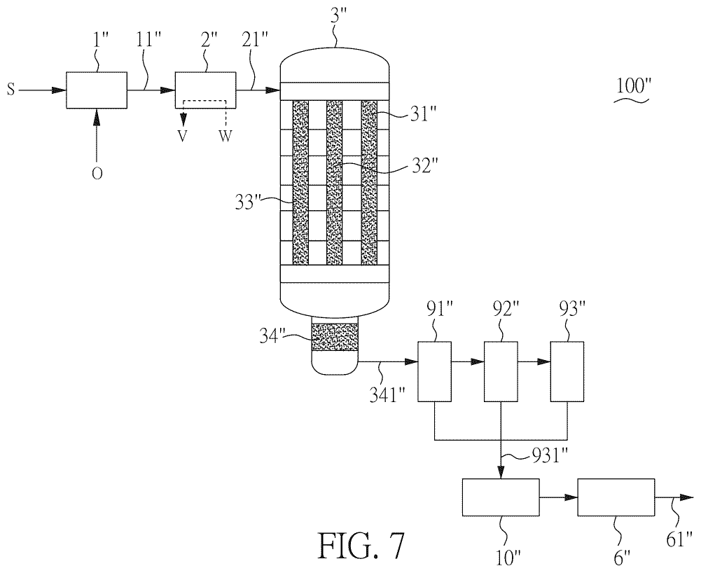

FIG. 7 is a system diagram showing a method for manufacturing electronic-grade sulfuric acid according to Embodiment 3 of the present invention, which mainly illustrates the aspect combining “pure oxygen burning” and “multi-stage condensation” of the present invention, but not limited thereto.

As shown in FIG. 7, FIG. 7 shows an electronic-grade sulfuric acid process system 100″, which includes a sulfur furnace 1″, a furnace 2″, a converter 3″, an evaporator 6″, a first condensing device 91″, a second condensing device 92″, a third condensing device 93″, and a storage tank 10″.

First, in the method for manufacturing electronic-grade sulfuric acid of the present invention, in the oleum manufacturing process in the front-end, sulfur S is used as sulfur-containing material, and the sulfur S is introduced through a sulfur spray gun (not shown) into the sulfur furnace 1″ for burning. The carrier gas used in the sulfur furnace 1″ is pure oxygen O. The sulfur dioxide gas 11″ is produced after the reaction and burning of the sulfur S and the pure oxygen O. Since the pure oxygen O does not need to undergo a water removal step before being introduced into the sulfur furnace 1″, the drying tower in the traditional sulfuric acid production process can be removed (that is, the drying tower 972 shown in FIG. 1 can be removed). Thus, the usage amount of industrial-grade sulfuric acid can be reduced, which has the advantage of reducing processing costs.

Based on the temperature range set for the first catalyst 31″, the second catalyst 32″, the third catalyst 33″ and the fourth catalyst 34″ in the converter 3″, the produced sulfur dioxide gas 11″ needs to be cooled by the furnace 2″ first, and the cooling mechanism by of the furnace 2″ is achieved by water W which absorbs heat and vaporizes into water vapor V. The cooled sulfur dioxide gas 21″ is introduced into a specially designed converter 3″, wherein the converter 3″ is similar to the converter 3 in Embodiment 1 and has similar characteristics and functions. The cooled sulfur dioxide gas 21″ passes through the first catalyst 31″, the second catalyst 32″, the third catalyst 33″, and the fourth catalyst 34″ in the converter 3″ in sequence, and is converted into high-concentration sulfur trioxide gas 341″. The sulfur trioxide gas 341″ is cooled and condensed by the first condensing device 91″, the second condensing device 92″, and the third condensing device 93″ connected in series into sulfur trioxide liquid 931″ and stored in the storage tank 10″. Since sulfur trioxide gas 341′ is directly converted into sulfur trioxide liquid 931″, it can not only improve the conversion efficiency and the product quality, but also reduce the industrial-grade sulfuric acid produced by exhaust gas absorption, achieving the goal of high quality and low waste emissions, and realizing the spirit of ESG sustainable development.

Next, in the electronic-grade sulfuric acid manufacturing process in the back-end, the obtained sulfur trioxide liquid 931″ is fed back into the evaporator 6″ of the electronic-grade sulfuric acid for evaporation to obtain evaporated sulfur trioxide gas. After electronic-grade purification, absorption by using the first solvent and stripping, and other processing steps (for simplicity, these processing steps are omitted in FIG. 7), electronic-grade sulfuric acid 61″ is finally obtained.

In this embodiment, the temperature of the sulfur dioxide gas 11″ before cooling, the temperature of the sulfur dioxide gas 21″ after cooling, the first solvent, the first catalyst 31″, the second catalyst 32″, the third catalyst 33″, and the fourth catalyst 34″ are similar to those described in Embodiment 1, and are not described again here. In addition, as similar to Embodiment 2, multiple condensing devices connected in series can also be used in this embodiment according to product requirements. Furthermore, the arrangement and the number of the aforementioned catalysts may also be adjusted according to actual needs.

### Experimental Example 1: Waste Acid Reduction Effect

Based on current production experience, when using the method for manufacturing electronic-grade sulfuric acid in the comparative embodiment as shown in FIG. 1 to prepare electronic-grade sulfuric acid, the output ratios of industrial-grade sulfuric acid and electronic-grade sulfuric acid are respectively 45% and 55% (that is, industrial-grade sulfuric acid:electronic-grade sulfuric acid=45:55), wherein 45% of the industrial-grade sulfuric acid is derived from dry air (18%) and exhaust gas absorption (27%). Since industrial-grade sulfuric acid has limited economic value, it must generally be disposed of as waste, and this is why it is called “waste acid”.

However, when using the method for manufacturing electronic-grade sulfuric acid in Embodiment 1, because it uses “pure oxygen” instead of air as the carrier gas, which contains almost or completely no moisture, the drying tower process can therefore be removed, thus reducing waste acid) by 18%. When using the method for manufacturing electronic-grade sulfuric acid in Embodiment 2, with the multi-stage condensation design of the series condensing devices to reduce the content of sulfur trioxide gas, the waste acid can be reduced by 21%. The method for manufacturing electronic-grade sulfuric acid in Embodiment 3 combines the methods for manufacturing electronic-grade sulfuric acid in Embodiment 1 and Embodiment 2, and thus the waste acid can be reduced by 39% in total.

### Experimental Example 2: Impurity Content of Electronic-Grade Sulfuric Acid

The concentrations of metals or their ions (that is, the impurity content) contained in the electronic-grade sulfuric acid prepared by the methods for manufacturing electronic-grade sulfuric acid in Embodiment 1 to Embodiment 3 of the present invention are shown in the following Table 1.

TABLE 1

| | | Specification | Analytical |
|---|---|---|---|
| Test item | Unit | value | value |
| Calcium (Ca) | ppb | 0.05 max. | 0.003 |
| Chromium (Cr) | ppb | 0.05 max. | <0.001 |
| Iron (Fe) | ppb | 0.05 max. | <0.003 |
| Nickel (Ni) | ppb | 0.05 max. | <0.001 |
| Potassium (K) | ppb | 0.05 max. | <0.002 |
| Zinc (Zn) | ppb | 0.05 max. | 0.009 |

As shown in Table 1, it proves that the present invention can prepare high-purity electronic-grade sulfuric acid, and its impurity content in the sulfuric acid belongs to “ppt grade”, which can be used as electronic-grade sulfuric acid for semiconductor manufacturing processes.

In summary, the method for manufacturing electronic-grade sulfuric acid of the present invention can have the special effect of simplifying equipment, reducing processing costs, or improving conversion efficiency and product quality. It can not only remove industrial-grade sulfuric acid produced by the drying tower process, but also reduce industrial-grade sulfuric acid produced by exhaust gas absorption, thereby achieving the goal of high quality and low waste emissions.

Although the present invention has been explained in relation to its embodiment, it is to be understood that many other possible modifications and variations can be made without departing from the spirit and scope of the present invention as hereinafter claimed.

What is claimed is:

1. A method for manufacturing electronic-grade sulfuric acid, comprising following steps:
providing sulfur-containing material;
burning the sulfur-containing material with pure oxygen to obtain sulfur dioxide gas;
converting the sulfur dioxide gas into sulfur trioxide gas; and
processing the sulfur trioxide gas to obtain electronic-grade sulfuric acid.

2. The method of claim 1, wherein the pure oxygen contains little or no moisture, and there is no need to perform a water removal step on the pure oxygen in the method for manufacturing the electronic-grade sulfuric acid.

3. The method of claim 1, further comprising a step of cooling the sulfur dioxide gas before the step of converting the sulfur dioxide gas into the sulfur trioxide gas.

4. The method of claim 3, wherein a temperature of the sulfur dioxide gas is between 900° C. and 1100° C. before cooling, and a temperature of the sulfur dioxide gas is between 300° C. and 500° C. after cooling.

5. The method of claim 1, wherein the sulfur dioxide gas is converted into the sulfur trioxide gas through a catalyst, and the catalyst is vanadium pentoxide or alumina.

6. The method of claim 1, wherein a first solvent is used to absorb the sulfur trioxide gas to obtain oleum, and the oleum is processed to obtain the electronic-grade sulfuric acid.

7. The method of claim 6, wherein the first solvent is sulfuric acid.

8. The method of claim 6, wherein the oleum is evaporated to obtain evaporated sulfur trioxide gas, and the evaporated sulfur trioxide gas is processed to obtain the electronic-grade sulfuric acid.

9. The method of claim 8, wherein a second solvent is used to absorb the evaporated sulfur trioxide gas to obtain the electronic-grade sulfuric acid.

10. The method of claim 9, wherein the second solvent is sulfuric acid.

11. The method of claim 1, wherein a condensing device is used to process the sulfur trioxide gas to obtain the electronic-grade sulfuric acid.

12. The method of claim 11, wherein a condensing device is used to condense the sulfur trioxide gas to obtain sulfur trioxide liquid, and the sulfur trioxide liquid is processed to obtain the electronic-grade sulfuric acid.

13. The method of claim 12, wherein the sulfur trioxide gas is condensed by a plurality of condensing devices connected in series.

14. The method of claim 12, wherein the sulfur trioxide liquid is evaporated to obtain evaporated sulfur trioxide gas, and the evaporated sulfur trioxide gas is processed to obtain the electronic-grade sulfuric acid.

15. The method of claim 14, wherein a first solvent is used to absorb the evaporated sulfur trioxide gas to obtain the electronic-grade sulfuric acid.

16. The method of claim 15, wherein the first solvent is sulfuric acid.

17. An equipment for manufacturing electronic-grade sulfuric acid, comprising:
a sulfur furnace;
a converter connecting to the sulfur furnace;
an absorption tower connecting to the converter;
an evaporator connecting to the absorption tower,
wherein sulfur-containing material is provided to the sulfur furnace, and the sulfur-containing material is burned with pure oxygen to obtain sulfur dioxide gas; the sulfur dioxide gas is converted into sulfur trioxide gas through the converter; and the sulfur trioxide gas is processed by the absorption tower and the evaporator to obtain electronic-grade sulfuric acid.

18. An electronic-grade sulfuric acid obtained by performing the method for manufacturing electronic-grade sulfuric acid of claim 1, wherein the electronic-grade sulfuric acid meets a specification value of any one of calcium, chromium, iron, nickel, potassium, and zinc less than 0.05 ppb.

19. The electronic-grade sulfuric acid of claim 18, which meets an analytical value of any one of calcium, chromium, iron, nickel, potassium, and zinc less than 0.009 ppb.
